(19) United States
(12) Patent Application Publication
(10) Pub. No.: US 2007/0300299 A1
(43) Pub. Date: Dec. 27, 2007

(54) Methods and apparatus to audit a computer in a sequestered partition

(76) Inventors: Vincent J. Zimmer, Federal Way, WA (US); Michael A. Rothman, Puyallup, WA (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/475,626

(22) Filed: Jun. 27, 2006

(51) Int. Cl. G06F 12/14

(52) U.S. Cl. 726/22

(57) ABSTRACT

Methods and apparatus are disclosed to audit a computer in a sequestered partition. An example method disclosed herein initializes a first processing unit and accesses sequestering code with the initialized first processing unit. The example method further initializes an embedded partition, the embedded partition including a sequestered runtime environment, executes an audit process, and initializes a general partition including an operating system. Other embodiments are described and claimed.

### FIELD OF THE DISCLOSURE

This disclosure relates generally to computer system platforms and auditing procedures thereon, and, more particularly, to methods and apparatus to audit a computer in a sequestered partition.

### BACKGROUND

Policies typically include one or more rules applied to a process, a business, and/or company assets to ensure proper use, execution, and prevention of abuse. For example, a record retention policy may include various rules that instruct an employee to delete archived e-mail that is older than a threshold date. Such policies may also include rules that disallow deletion of particular files after an audit has been initiated. Computers, servers, and/or computing networks may execute the policies and any rules thereof.

Policy enforcement typically includes one or more rules that are monitored and executed by a process. A periodic or random schedule may invoke the process to analyze any particular situation for policy compliance as defined by the one or more rules. Some processes operate as software programs executed on computing devices, personal computers, workstations, and/or servers (hereinafter “computer(s)” or “platform(s)”). The policy enforcement and/or process, embodied as an executable program stored in a volatile and/or non-volatile memory, is executed by one or more central processing units (CPUs) of the computer.

Policy invocation typically results in the wake of economic and/or capital asset abuses. Additionally, some policies may be invoked as a preventative measure to protect corporations, employees, customers, and/or citizens from abusive, deceitful, and/or criminal conduct. Other policies may be directed to various controls to minimize and/or prevent business fraud and/or ensure appropriate financial public disclosures. In particular, today's business environment includes financial reporting primarily driven by Information Technology (IT) systems, in which such IT systems play a vital role in ensuring compliance with enforcing the various policies.

Computers employed by the IT systems may execute various policy driven processes to maintain document security and tracking (e.g., authorized and unauthorized document edits, deletions, etc.). Processes, such as executable software, operate on computer platforms under third party operating system (OS) control that may be susceptible to various circumvention techniques that prevent successful policy enforcement due to, for example, OS vulnerabilities and process overrides. Furthermore, even where the processes detect various policy violations, the third party OS may expose vulnerabilities that could result in unauthorized access to violation logs, thereby potentially enabling a policy violator, a hacker, etc., to cover-up details of the breach.

### BRIEF DESCRIPTION OF THE DRAWINGS

FIG. 1 is a block diagram showing an example computer platform having a sequestered partition.

FIG. 2 is a block diagram showing an example computer platform to audit a computer in a sequestered partition.

FIGS. 3 and 4 are flowcharts illustrating example processes to audit a computer in a sequestered partition.

### DETAILED DESCRIPTION

Computer and/or computer system auditing ensures that computing resources, corporate and private data files, and/or protective policy regulation(s) are enforced. For example, Congress proffered the Sarbanes-Oxley (SOX) Act of 2002, also known as the Public Company Accounting Reform and Investor Protection Act, which establishes public company oversight, corporate responsibility, and enhances corporate financial disclosures. The SOX Act responded to, in part, an overstated corporate earnings report of approximately $3 billion that produced devastating effects on employees, retirees, and worldwide investors.

The SOX Act, in part, requires a design of controls related to corporate financial disclosures and fraud detection. Under the Act, companies must provide attestation of internal control assessment. In addition to financially driven public corporation disclosure policies, such as those proffered by the SOX Act, auditing may protect people from fraudulent use and/or disclosure of protected personal and/or health related information. The Health Insurance Portability and Accountability Act (HIPAA) was enacted by the United States Congress in 1996 to, in part, establish national standards for electronic health care transactions for health care providers (e.g., doctors offices, hospitals, etc.), health insurance plans, and employers. The standards require, among other things, that individuals' protected health information not be used for marketing purposes without the explicit consent of the involved individuals. The standards also require, for example, that any transfer of protected health information across a computer system be protected from interception and/or intrusion. Thus, some form of encryption must be utilized for the transfer of electronic files. Each entity charged with responsibility under HIPAA (e.g., doctors offices, health insurance companies) must ensure that data within its systems (e.g., computers, computer networks, etc.) not be changed and/or erased in an unauthorized manner. As such, HIPAA policies may require the use of checksums, double-keying, message authentication, and/or digital signatures to ensure data integrity. Accordingly, computers and computer systems play a significant role in the enforcement of various auditing procedures and/or policy rules.

A computer, such as a computer chartered with the responsibility of enforcing various policies (e.g., HIPAA, SOX, etc.), has a particular set of hardware that, when working together, allows the computer to execute an operating system (OS), such as Windows®, Linux, etc. Such computers may include personal computers (PCs), workstations, personal digital assistants (PDAs), kiosks, and servers. Furthermore, upon successful initiation of an operating system, the computer may thereafter execute particular user applications, such as word processing applications, spreadsheet applications, Internet browser applications, games, policy enforcement applications/procedures, and/or other custom and/or commercial applications.

Prior to executing the applications, the operating system typically initializes and takes control of the computer system hardware, including hard drive(s), memory, input/output (I/O) facilities including, but not limited to disk adapters, compact disk (CD) drives, digital versatile disk (DVD) drives, local area network (LAN) adapters, serial ports, terminals, graphics/audio cards, etc. The operating system is itself a software application read from a hard drive, thus a base level initialization of the underlying hardware is accomplished via basic input/output system (BIOS) procedures before the operating system may take overall control of the computer. Base level initialization may include initialization of computer components such as, for example, main memory (e.g., random access memory (RAM)), FLASH memory, a non-volatile storage (e.g., a hard drive), CPUs, and/or various chipsets.

BIOS initialization of the platform typically results in an OS having full awareness of hardware and software resources available to it. Alternatively, some platforms employ platform partitioning, in which one or more CPUs support virtual machines (VMs). Each VM is a partition that executes its own OS and/or applications, wherein the OS is unaware that it is sharing various resources, such as sharing CPU resources, memory, hard disk space, and/or input/output (I/O) devices. Support for each partition may be facilitated by a virtual machine monitor (VMM), which is software that operates between underlying platform hardware and the VMs. For each instance of a VM, which may be running an OS and/or various executable applications, the VMM manages underlying hardware resources that include, but are not limited to, CPU access time (e.g., time slicing), hard disk space, and memory space to provide execution resources for each VM. The VMM is typically proprietary software that is designed, managed, and updated by third parties, thus CPU hardware manufacturers and/or any users of platforms that employ multiple partitions via the VMM have little or no control over potential security vulnerabilities that exist in the VMM.

Similarly, even platforms that employ a single CPU may utilize an OS that maintains full control over all underlying hardware, including memory access, hard drive access, memory and drive partitions, and/or network interface card control. As such, the OS may include various vulnerabilities that permit access, control, and/or identification of underlying policy enforcement applications that execute on the platform. Assuming such vulnerabilities are discovered, a hardware designer, manufacturer, or user still has little or no control over when the OS manufacturer will provide a patch and/or service pack that abates the vulnerability.

Such exposure, in both the VMM context and the OS context, is particularly troublesome when applying auditing processes, such that those enforcing one or more policies. Auditing of activities can occur by virtue of an OS application, a VMM, and/or intelligent I/O. However, each of these auditing approaches fails to decouple the hardware (e.g., CPUs, memory, hard drives, network cards, etc.) from the third party OS and/or VMM.

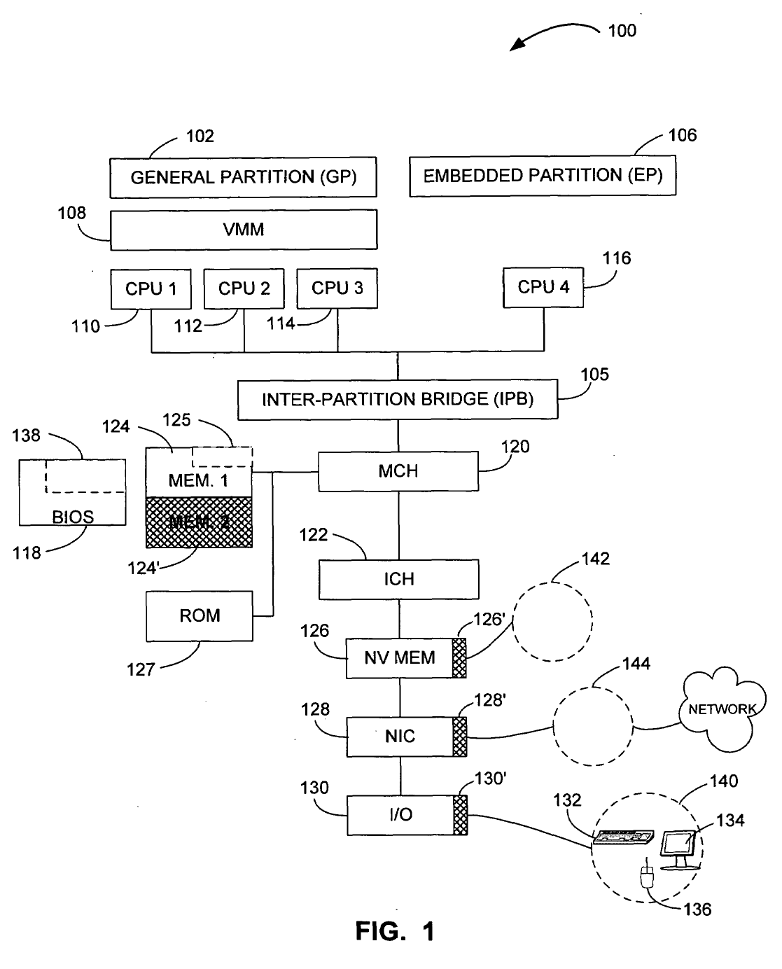

FIG. 1 is a diagram of an example computer platform 100 to audit in a sequestered partition. Generally speaking, a sequestered element and/or process of the platform 100 is transparent and/or undetected by a conventional OS. The sequestered element(s) and/or process(es) typically operate under the control of an independent process and/or hardware, as discussed in further detail below. The example platform 100 of FIG. 1 includes a general partition (GP) 102, which may execute a shrink-wrapped third-party OS (e.g., Microsoft® Windows®, a Linux distribution, etc.). The GP 102 is operatively connected by an inter-partition bridge (IPB) 104 to an embedded partition (EP) 106, which is a sequestered executable running on a sequestered processor. The IPB 104 may be a shared memory buffer between the GP 102 and the EP 106, or a hardware interconnect. The IPB 104 may generate an interrupt to the EP 106 to process I/O requests generated by the third-party OS executing on the GP 102. The GP 102 will typically employ various console filter drivers (e.g., for video display, keyboard, mouse, etc.), such as Windows® I/O Request Packets (IRPs). In response to the interrupt generated by the IPB 104, the EP 106 may be capable of determining I/O activity, including, but not limited to, hard drive file access attempts, file edit attempts, file deletion attempts, e-mail transmission attempts, and/or identification of web site addresses matching policy criteria, as discussed in further detail below.

The example platform 100 also includes a VMM 108 to support creation and management of VMs (some of which may host the GP) that may use one or more CPUs 110, 112, 114. A fourth CPU 116 may be sequestered by a BIOS 118 to service the EP 106. The example platform 100 can be implemented by one or more general purpose microprocessors, microcontrollers, a server, a personal computer, a personal digital assistant (PDA), or any other type of computing device.

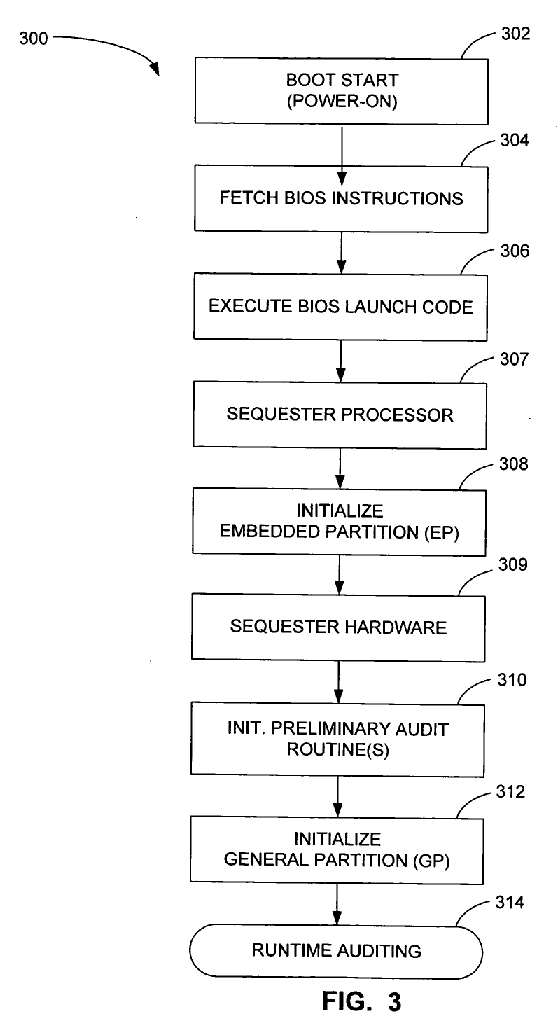

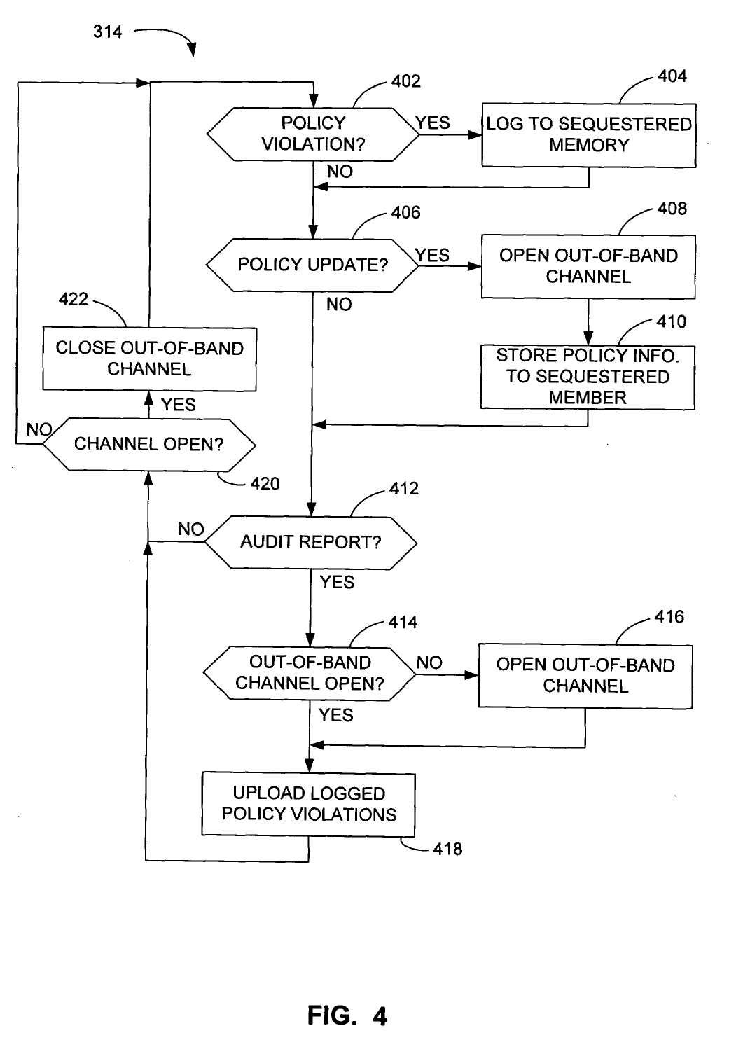

The example platform 100 of the example of FIG. 1 includes four CPUs 110, 112, 114, and 116, each of which may execute coded instructions 125 present in, for example, an external RAM 124 and/or a memory of the processor(s). The processors may be any type of processing unit, such as a microprocessor from the Intel® families of microprocessors. Of course, other processors from other families are also appropriate. The processors may execute, among other things, the example machine accessible instructions of FIGS. 3 and 4, described in further detail below, to implement auditing in a sequestered platform in the example system of FIG. 1.

All CPUs 110, 112, 114, 116 are operatively connected to a memory controller hub (MCH) 120 and an I/O controller hub (ICH) 122. The MCH 120 provides an interface for the CPUs and memory 124, balances system resources, and enables concurrent processing for either single or multiple CPU configurations. The ICH 122 forms a direct connection from hard disk drive(s) 126, network interface cards 128 (NICs), and/or various I/O devices 130 (e.g., universal serial bus (USB) ports, serial ports, keyboard 132, mouse 134, and/or video 136) to the main memory 124.

The hard disk drive(s) 126 may be any type of mass storage device, including floppy disk drives, hard drive disks, compact disk drives, and digital versatile disk (DVD) drives.

The NIC 128 may be any type of communication device, including a modem, to facilitate exchange of data with external computers via a network (e.g., an Ethernet connection, a digital subscriber line (DSL), a telephone line, coaxial cable, a cellular telephone system, etc.).

The processors 110, 112, 114, 116 are in communication with the main memory (including a read only memory (ROM) 127) via a bus 129 interconnecting platform elements. The RAM 124 may be implemented by dynamic random access memory (DRAM), Synchronous DRAM (SDRAM), and/or any other type of RAM device, and ROM may be implemented by FLASH memory and/or any other desired type of memory device.

The BIOS 118 includes sequestering code 138 to sequester various platform 100 resources before the GP 102, and any corresponding VMs and/or OSs begin to take operational control over the various platform 100 hardware resources. For example, the sequestering code 138 may be stored on a non-volatile memory 126, such as FLASH memory, read only memory (ROM), and/or complementary metal oxide semiconductors (CMOS). The sequestering code 138 may include instructions to initialize various platform hardware systems and/or components in a particular order. For example, during computer power-up, the CPU(s) may execute the sequestering code in a pre-boot, or pre-OS, environment to sequester CPU 4 (116) by initializing chipset(s) and/or other motherboard components associated with CPU 4 (116) while leaving CPUs 1, 2, and 3 (110, 112, 114) in a non-powered state. Although CPU 4 (116) is ready to execute after a reset, it has no instructions at very early stages of the BIOS boot procedures. As such, the CPU typically begins execution at a memory location/address hard-coded by the CPU or chipset. Such memory locations may be chipset and/or CPU dependent or compatible with industry standard locations. By way of illustration, and not limitation, a hard-coded memory location/vector may be near the end of non-volatile memory 126 and then “jump” to an alternate memory location for further instructions. For example, after CPU 4 (116) begins execution, the jump instruction in the non-volatile memory 126 may point to additional boot instructions, including the sequestering code 138.

Additional BIOS instructions, executed pursuant to the sequestering code 138, may cause CPU 4 (116) to run the EP 106 as a sequestered runtime, such as ThreadX® or Embedded Linux. Persons of ordinary skill in the art will appreciate that ThreadX® is a real-time operating system (RTOS) well-suited for embedded applications. RTOSs are typically focused to perform a specific suite of functions, thereby include a relatively small footprint (i.e., they do not occupy much memory or use many processing resources) and operate much faster as compared to commercial general purpose OSs. The sequestering code 138 may direct the sequestered CPU 4 (116) and EP 106 to further sequester additional components of the platform 100 and/or portions thereof. For example, the EP 106 may sequester a portion of the memory 124′, a portion of the non-volatile memory 126′, a portion of the NIC 128′, and/or a portion of the I/O 130′. For ease of illustration, the sequestered portions of the platform 100 are shown as crosshatched in FIG. 1. Sequestered platform 100 components and/or portions of such sequestered components are neither available to the GP 102, nor detected by the GP 102, as discussed in further detail below.

The sequestering code 138 may direct the BIOS to initiate boot instructions for the balance of the platform 100 upon completion of EP 106 initialization and/or component sequestering. BIOS instructions may include, but are not limited to, performing power-on self test (POST) procedures on the memory 124, the non-volatile memory 126 (e.g., hard drive(s)), the NIC 128, and/or various I/O 130, such as a keyboard 132 test, a mouse 134 test, and/or video 136 output test(s). The GP 102 may execute a shrink-wrap OS, such as Microsoft® Windows® or Linux, for example. Generally speaking, upon completion of BIOS boot procedures, both the GP 102 and the EP 106 are independently executing. However, the GP 102 is unaware of the EP 106 and cannot access resources allocated to the EP 106. Furthermore, the GP 102 is unaware of any components that have been sequestered in whole or in part, such as the sequestered memory 124′, the sequestered non-volatile memory 126′ (e.g., several megabytes of hard disk space), the NIC 128′, and/or the I/O 130′.

Policy rules and/or procedures may be stored in the sequestered portion of the non-volatile memory 126′. The policies may include HIPAA regulations, SOX Act regulations, and/or custom policy rules that any user may choose to implement. For example, a company may design policy rules to prevent employees from misusing company equipment, such as computers, computer data files, and/or Internet access use violations. If an employee, or any other user of the platform 100 visits a website, the EP can monitor/audit such Internet address activity 144, compare it to a list of restricted websites stored (as a policy) in the sequestered portion of non-volatile memory 126′, and store the date and time of such violation in the sequestered non-volatile memory 126′. The EP 106 operates independently of the GP 102 and any OS that may be executed on the GP 102, thus the potentially infringing employee will not be able to search OS process information and detect the existence of the EP 106, and/or any policy audit processes 144 executed by the EP 106. Furthermore, because the sequestered portion of the non-volatile memory 126′ is not available to the GP 102, the potentially infringing employee may not access such memory 126′ to search for or remove evidence of the offending conduct after it is logged thereto.

The EP 106 may also invoke the sequestered I/O 130′ to detect/audit I/O activity 140, such as keystrokes of the keyboard 132. Keystroke auditing may include, but is not limited to, detecting predetermined website addresses, time-of-day keyboard use, and/or language deemed to be offensive. The EP 106 may also audit/detect particular file actions 142, such as whether a file has been deleted and/or edited. For example, the file action audit 142 may monitor for deletion activities of a particular hard drive folder, and/or network drive. If any such deletion actions have occurred, the EP 106 may block the deletion from occurring, and/or allow the deletion while making a backup copy to the sequestered non-volatile memory 126′. An administrator and/or company security personnel may subsequently retrieve the backup copy of the deleted file to determine whether such conduct was authorized. Despite a file deletion and/or editing being unauthorized, authorized, and/or accidental, the security personnel have a copy of the original document as a backup.

Policy updates, such as policy rules stored in the sequestered non-volatile memory 126′, may occur via the NIC 128. The sequestered portion of the NIC 128′ may include a separate media access control (MAC) address known only by the administrator and/or entity chartered with the responsibility for platform 100 auditing. The sequestered portion of the NIC 128′ may, additionally or alternatively, include an out-of-band channel, such as a network port, available only to the EP 106. As a result, any updates to the EP 106 may occur without constraint, awareness, or authorization by the GP 102. The administrator may connect to the platform 100 via any network (e.g., the Internet) by way of the sequestered NIC 128′ and gain access to the EP 106. Authentication procedures may be implemented by the EP 106 and/or the sequestered NIC 128′ to prevent unauthorized access to the platform 100. For example, as new policy rules are deemed necessary for the platform 100, such as an updated list of restricted web sites, the administrator may access the platform 100 via the sequestered NIC 128′, authenticate with the sequestered NIC 128′ and/or EP 106, and upload new and/or alternate policy information. Persons of ordinary skill in the art will appreciate that authentication may be accomplished via any network security protocol, such as secure sockets layer (SSL), transport layer security (TLS), and/or any other cryptographic protocols to provide secure communications.

Update information may also include changes and/or additions to the sequestering code 138. For example, while the example sequestering code 138 may have initially sequestered one megabyte of non-volatile hard-drive space 126′, a sequestering code 138 update may instruct the BIOS to sequester more or less space, as needed. Additionally, the sequestering code 138 may instruct the BIOS to sequester additional CPUs, additional I/O device(s), and/or any other auditing procedures.

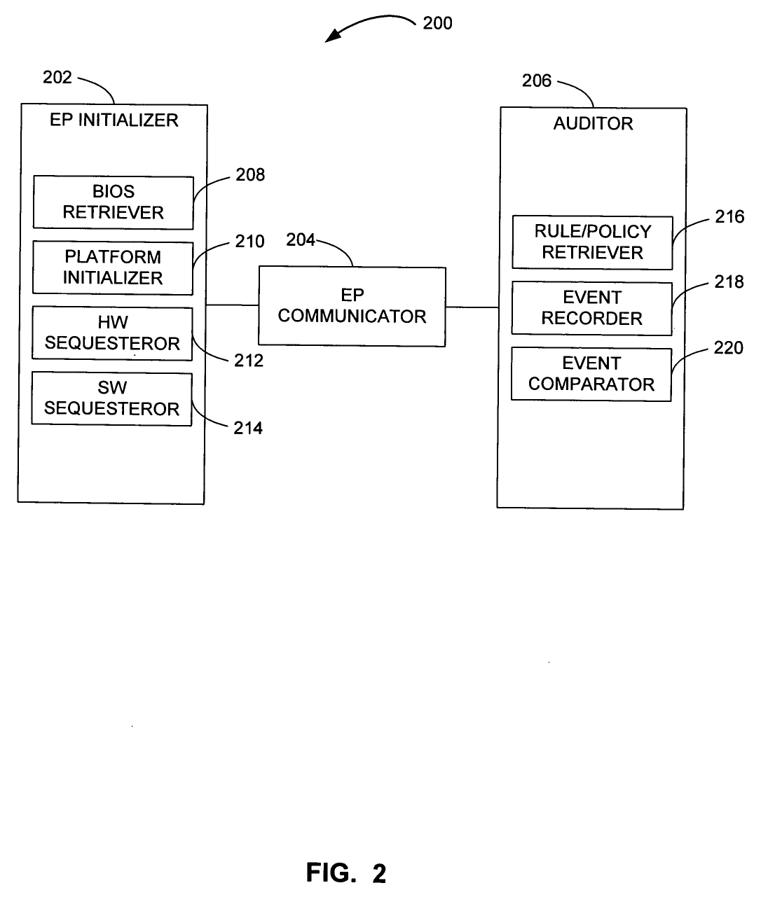

FIG. 2 is a diagram of an example system to audit in a sequestered partition 200. The example system to audit in a sequestered partition 200 includes an EP initializer 202, an EP communicator 204, and an auditor 206. The EP initializer 202 may include a BIOS retriever 208, a platform initializer 210, a hardware sequesteror 212, and/or a software sequesteror 214. The EP initializer 202 may also include a BIOS, such as the BIOS 118 of FIG. 1, to initialize the platform 100 in a manner to facilitate auditing. The BIOS retriever 208 may search for and begin execution of the BIOS instructions. Additionally, the BIOS retriever 208 may employ the platform initializer 210, which may power-up and initialize particular facets of the platform, such as, for example, motherboard chipsets and/or other electronic platform components. The EP initializer 202 may also include sequestering code, such as the example sequestering code 138 of FIG. 1, to work cooperatively with the BIOS 118 and the hardware sequesteror 212 to identify and sequester various platform resources to be used during policy auditing procedures. The sequestering code 138 of the EP initializer may, in part, provide instructions to sequester one or more CPUs, volatile and/or non-volatile memory, I/O devices, and/or network communication devices. The EP initializer 202 may also employ the software sequesteror 214 to determine when the sequestered CPU, and/or other sequestered hardware is ready to enable execution of a sequestered runtime, such as ThreadX or Embedded Linux, which may further execute portions of sequestering code 138 to sequester various platform 100 components used for auditing purposes. The software sequesteror 214 may also identify when the EP is fully initialized before allowing any third party software from executing on the platform, such as an OS and/or a VMM.

The EP initializer 202 is operatively connected to the EP communicator 204, which may include an inter-partition bridge (IPB) to facilitate communication between the EP 106 and other components of the platform 100. While the GP 102 responds to inputs from a user, such as a company employee being monitored pursuant to policy rules, the GP 102 thinks that it is interacting with various platform components directly via the IPB 104. For example, the EP 106 may resemble a video or input device. Any OS console filter drivers of the GP 102, such as video displays, keyboard inputs, and/or mouse inputs, route through the IPB 104 and are seen by the EP 106. As a result, the EP 106 may monitor any activity of the GP 102 and the user(s) interacting with it while the auditing activities of the EP 106, including sequestered hardware and portions thereof, remain undetected by the GP 102.

The auditor 206 may include a rule/policy retriever 216, an event recorder 218, and/or an event comparator 220. Additionally, the auditor 206 is operatively connected to the EP communicator 204 to carry out policy rules and/or audit the activities performed by the platform 100. For example, the auditor 206 may retrieve stored policy rules with the rule/policy retriever 216, wherein such policies and/or rules may be located in the sequestered non-volatile memory 126′. Based on various procedures, instructions, and/or rules, the event recorder 218 may monitor and record events (that violate the stored policy rules) to that same sequestered memory 126′. Events that pass through the IPB of the EP communicator 204 (e.g., keypresses, I/O device usage, web page access, etc.) may be compared (by the event comparator 220 of the auditor 206) to stored policy rules, resulting in either an event flag, or no action, depending upon whether such events match predetermined policy parameters. As discussed above, policy parameters/rules may include, but are not limited to, unauthorized web addresses, suspect keyboard key combinations indicative of offensive language, attempts to access, create, modify, and/or delete files, and/or I/O device usage outside a time-of-day threshold (e.g., prohibition of computer usage past 6:30 PM). Alternatively, the auditor 206 may store policy violations to the sequestered memory 124′ and/or report policy violations via the sequestered NIC 128′ as a socket communication, an e-mail message, and/or a file transfer to a network, such as an intranet and/or the Internet.

Having described the architecture of one example system that may be used to audit a computer in a sequestered partition, various processes are described. Although the following discloses example processes, it should be noted that these processes may be implemented in any suitable manner. For example, the processes may be implemented using, among other components, software, or firmware executed on hardware. However, this is merely one example and it is contemplated that any form of logic may be used to implement the systems or subsystems disclosed herein. Logic may include, for example, implementations that are made exclusively in dedicated hardware (e.g., circuits, transistors, logic gates, hard-coded processors, programmable array logic (PAL), application-specific integrated circuits (ASICs), etc.) exclusively in software, exclusively in firmware, or some combination of hardware, firmware, and/or software. Additionally, some portions of the process may be carried out manually. Furthermore, while each of the processes described herein is shown in a particular order, those having ordinary skill in the art will readily recognize that such an ordering is merely one example and numerous other orders exist. Accordingly, while the following describes example processes, persons of ordinary skill in the art will readily appreciate that the examples are not the only way to implement such processes.

FIG. 3 is a flowchart of an example process 300 to audit in a sequestered partition. The platform 100 is powered-on from an inactive state and/or a platform 100 reset is initiated to initiate a power-on reset (block 302). Power-on of the platform 100 may include initialization of one or more CPUs, such as CPU 1, 2, 3, and/or 4 (110, 112, 114, and 116, respectively). If one of the CPUs is designated to initialize first, such as CPU 1 (110), it may be hard-coded to access a specific memory location. In particular, the chipset or CPU is typically hard-coded to fetch the first BIOS boot instructions during power-up at the top of an addressable memory (block 304), such as non-volatile memory (e.g., read only memory (ROM), electrically erasable programmable read only memory (EEPROM), FLASH memory, complementary metal oxide semiconductors (CMOS), etc.). BIOS instructions may include varying degrees of complexity and length, thus a jump instruction of the addressable memory may redirect BIOS execution to an alternate memory device and/or location, such as the sequestering code 138 of FIG. 1 (block 306). The sequestering code may execute instructions to sequester a CPU different from the particular CPU that initializes upon power-up of the platform (block 307). As discussed above in view of FIG. 1, the platform 100 may have several CPUs, one of which is to be dedicated to auditing processes. While the illustrated example of FIG. 1 shows CPU 4 (116) as the CPU designated for EP 106 execution, the sequestering instructions may sequester any of the available CPUs (block 307) of an example platform.

The sequestering code execution (block 306) may instruct the currently operating CPU 110 to prepare various other facets of the platform for operation. As discussed above, despite CPU 1 (110) initializing first after power-up (block 302), the sequestering code 138 may instruct the platform 100 to initialize CPU 4 (116) and transfer all remaining initialization procedures thereto. Alternatively, any one of the CPUs may be the first to initialize after power-on, and depending on specific sequestering code 138 instructions, any one of the other CPUs may “take over” control of subsequent initialization procedures. The sequestering code 138 includes instructions for an embedded partition (EP) to execute a sequestered runtime environment (block 308), such as the ThreadX® RTOS, as discussed above. The EP may receive further initialization instructions from the sequestering code 138, and/or initialization instructions stored in the sequestered non-volatile memory 126′. Such additional sequestering code 138 instructions may include, but are not limited to, instructions to sequester other hardware elements of the example platform 100 (block 309). Additionally, or alternatively, all of the initialization instructions and/or auditing policies may be stored in the sequestering code 138, which is unavailable to and undetected by the GP.

Preliminary auditing routines to enforce platform 100 policies are initialized by the EP 106 (block 310). When the preliminary auditing routines are executing, the GP is initialized (block 312) to execute a third-party OS, such as, for example, a Microsoft® Windows® operating system, or a Linux operating system. Persons of ordinary skill in the art will appreciate that initializing the EP 106 and the preliminary auditing procedures, before the GP execution begins, allows the preliminary auditing procedures to catch any processes executed by the GP. For example, OSs typically initiate many executable processes during the initialization process, such as HIPAA related policies, SOX related policies, anti-virus programs, and/or network drive mapping. Similarly, computer viruses and/or savvy computer users may know of various methods to circumvent such processes to further objectives repugnant to the auditing policies. The EP 106 is initialized and monitoring for policy violations prior to initialization and execution of the GP 102, thus deviant activities may be thwarted before causing any damage and/or breach of security. Upon completion of GP initialization, in which the third party OS typically becomes aware of various platform 100 resources (e.g., memory 124, hard drive(s) 126, NICs 128, etc.), runtime auditing (block 314) begins and monitors for policy violations and/or policy updates, as discussed below.

FIG. 4 is a flowchart of the example process for runtime auditing 314. Policy rules, stored on the platform 100 in the sequestering code 138, stored in the sequestered volatile memory 124′, and/or stored in the sequestered non-volatile memory 126′, are compared against platform 100 activities (block 402). For example, all activities performed by a platform 100 user via the I/O 130 (such as via the keyboard 132, the mouse 134, the monitor 136, floppy drives, CD burners, etc.) pass through the IPB 104 of the example platform 100. The EP 106, which is executed by the sequestered CPU 4 (116) monitors platform 100 actions that pass through the IPB 104. When a violation is detected (block 402), such as a user attempt to delete privileged files, the event is logged to a sequestered memory location (block 404), such as the sequestered non-volatile memory 126′.

The EP 106 may determine whether policy updates are available (block 406) on a periodic basis (e.g., once per day, once per week, etc.), and/or receive external notification that policy updates are available. For example, the EP 106 may open an out-of-band channel via the sequestered portion 128′ of the NIC 128 (block 408). System administrators and/or other persons chartered with policy enforcement for computer platforms and/or systems may allow the platform 100 to connect to a secure network drive and/or network address containing policy rules. Such policy rules may be downloaded by the platform 100 and stored to the sequestered portion 126′ of the non-volatile memory 126 (block 410). Persons of ordinary skill in the art will appreciate that, rather than the platform 100 performing a periodic check for updated policy information, the platform may be responsive to forced external updates via the secure out-of-band channel accessible via the sequestered portion 128′ of the NIC 128. Administrators and/or other persons chartered with platform auditing enforcement may use a secondary/separate MAC address of the NIC 128 that is unknown to the GP 102. As such, the administrator(s) may access all such platforms under their domain of responsibility and “push” updates thereto via the out-of-band channel(s).

The EP 106 may also determine whether an audit report should be communicated to the administrator(s) (block 412) on a periodic basis, and/or upon the external request via the sequestered portion 128′ of the NIC 128, as discussed above. If an audit report should be generated, which communicates instances of policy violations (if any), the EP 106 determines whether the out-of-band channel is still open (block 414). If not, then the out-of-band channel is opened (block 416) and the log of policy violation instances stored in the sequestered non-volatile memory 126′ is transmitted to the system administrator(s) (block 418). The EP 106 determines whether the out-of-band channel is still open (block 420) and closes it if necessary (block 422). The runtime auditing process 314 repeats as long as the platform 100 is operating.

Although certain apparatus constructed in accordance with the teachings of the invention have been described herein, the scope of coverage of this patent is not limited thereto. On the contrary, this patent covers every apparatus, method and article of manufacture fairly falling within the scope of the appended claims either literally or under the doctrine of equivalents.

What is claimed is:

1. A method of auditing a computer comprising:
initializing a first processing unit;
accessing sequestering code with the initialized first processing unit;
initializing an embedded partition comprising a sequestered runtime environment;
executing an audit process; and
initializing a general partition comprising an operating system.

2. A method as defined in claim 1 further comprising a second processing unit to execute the operating system.

3. A method as defined in claim 1 wherein the audit process monitors the computer using an inter-partition bridge.

4. A method as defined in claim 3 further comprising masking the embedded partition as an input/output device.

5. A method as defined in claim 4 wherein the general partition interprets the embedded partition as the input/output device through the inter-partition bridge.

6. A method as defined in claim 1 further comprising monitoring computer activity for policy violations via the audit process.

7. A method as defined in claim 6 wherein the computer activity comprises at least one of file access, file deletion, file modification, network access, or input/output activity.

8. A method as defined in claim 1 further comprising logging a policy violation to a sequestered memory.

9. A method as defined in claim 1 further comprising updating the computer with a policy, the policy enforced by the audit process.

10. A method as defined in claim 9 wherein the updated policy is received via a sequestered network card.

11. A method as defined in claim 9 wherein the updated policy is stored in a sequestered memory.

12. An apparatus to audit a computer comprising:
a first processing unit to execute an embedded partition;
a second processing unit to execute a general partition; and
an inter-partition bridge, the embedded partition to monitor general partition activity via the inter-partition bridge.

13. An apparatus as defined in claim 12 further comprising a sequestered runtime environment executing in the embedded partition.

14. An apparatus as defined in claim 13 wherein the sequestered runtime environment comprises a real-time operating system.

15. An apparatus as defined in claim 12 further comprising a sequestered memory to store a policy.

16. An apparatus as defined in claim 15 wherein the embedded partition compares the monitored general partition activity with the policy to determine a policy violation.

17. An apparatus as defined in claim 15 further comprising a sequestered network card to receive updates to the policy.

18. An apparatus as defined in claim 15 wherein the policy comprises at least one of an input/output usage policy, a network usage policy, or a file access policy.

19. An apparatus as defined in claim 12 wherein the inter-partition bridge masks the embedded partition as an input/output device.

20. An article of manufacturing storing machine readable instructions which, when executed, cause a machine to:
initialize a first processing unit;
access sequestering code with the initialized first processing unit;
initialize an embedded partition comprising a sequestered runtime environment;
execute an audit process; and
initialize a general partition comprising an operating system.

21. An article of manufacture as defined in claim 20, wherein the machine readable instructions cause the machine to execute the operating system with a second processing unit.

22. An article of manufacture as defined in claim 20, wherein the machine readable instructions cause the audit process to monitor the computer with an inter-partition bridge.

23. An article of manufacture as defined in claim 22, wherein the machine readable instructions mask the embedded partition as an input/output device.

24. An article of manufacture as defined in claim 20, wherein the machine readable instructions cause the machine to monitor computer activity for policy violations via the audit process.

25. An article of manufacture as defined in claim 24, wherein the machine readable instructions cause the machine to monitor for at least one of file access, file deletion, file modification, network access, or input/output activity.

26. An article of manufacture as defined in claim 20, wherein the machine readable instructions cause the machine to log a policy violation to a sequestered memory.

27. An article of manufacture as defined in claim 20, wherein the machine readable instructions cause the machine to update the computer with a policy, the policy enforced by the audit process.

28. An article of manufacture as defined in claim 27, wherein the machine readable instructions cause the machine to receive the updated policy via a sequestered network card.

29. An article of manufacture as defined in claim 27, wherein the machine readable instructions cause the machine to store the updated policy to a sequestered memory.
